(19) United States
(12) Patent Application Publication
(10) Pub. No.: US 2025/0342773 A1
(43) Pub. Date: Nov. 6, 2025

(54) SYSTEM AND METHOD FOR MOVEMENT-BASED LEARNING USING INTERACTIVE MATS

(71) Applicants: Suzanne Kuntz, Ithaca, NY (US); Emily Kuntz, Ithaca, NY (US)

(72) Inventors: Suzanne Kuntz, Ithaca, NY (US); Emily Kuntz, Ithaca, NY (US)

(21) Appl. No.: 18/652,300

(22) Filed: May 1, 2024

(51) Int. Cl. G09B 5/02; G06F 3/042; G09B 7/00

(52) U.S. Cl. CPC G09B 5/02; G06F 3/0425; G09B 7/00

(57) ABSTRACT

A system for movement-based learning using a mat and computer system is disclosed, including a mat having a plurality of spaces each having a number displayed thereon. The mat is dimensioned to be stood upon by a student engaged in a movement-based learning activity. At least one user computing device is in operable connection with a user network. An application server is in operable communication with the user network to host an application system for providing a virtual classroom environment via a user interface module. A learning module provides at least one lesson associated with a concept to be learned using the mat as a learning enhancement tool. An assessment module provides assessments associated with the concept. An analysis module analyzes student inputs to the assessment interface and evaluates the student input to determine if the user input is correct. Results are displayed on a progress reports interface.

### TECHNICAL FIELD

The embodiments generally relate to systems, methods, and devices for movement-based learning using a physical object and a computer-implemented application program.

### BACKGROUND

Education is an essential component of childhood development. In particular, mathematics education, including numeracy skills, are especially important in today's society. Mathematics education attempts to teach a variety of different objectives. As a base-level learning principle, numeracy skills (e.g., the ability to tell time, count money, and carry out simple arithmetic), are important for building a foundation of knowledge upon which more complex mathematics can be learned upon.

Many methods exist for teaching mathematics. Conventional approaches included the systematic guidance of students through various mathematical concepts. More recently, computer-based mathematics software has been developed to teach the principles of mathematics and has become widely adopted in the modern world. To test students learning progression, various standards have been established which can be tested.

It is known that individuals respond differently to different methods of learning. Instructors are constantly looking to improve their teaching modalities and provide an engaging learning environment for students.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to systems and methods for movement-based learning using a mat and computer system. The system includes a mat having a plurality of spaces each having a number displayed thereon. The mat is dimensioned to be stood upon by a student engaged in a movement-based learning activity. At least one user computing device is in operable connection with a user network. An application server is in operable communication with the user network to host an application system for providing a virtual classroom environment via a user interface module. A learning module provides at least one lesson associated with a concept to be learned using the mat as a learning enhancement tool. An assessment module provides assessments associated with the concept. An analysis module analyzes student inputs to the assessment interface and evaluates the student input to determine if the user input is correct. Results are displayed on a progress reports interface.

The mat is used as a teaching aid and can be provided in various configurations. In the illustrated examples provided herein, the mat is used to aid in teaching mathematical concepts such as arithmetic (e.g., addition, subtraction, multiplication, and division). The mat provides an engaging means of teaching the concepts by allowing the students to move across the surface of the mat while solving mathematical problems. This provides a means of learning concepts in a way that is both physically and mentally engaging for the student. Creating mats with various configurations of spaces and numbers provides evolving ways for learning various concepts, and thus helps to avoid a stagnant and boring learning environment.

The system includes an application program accessible via a computer system. The application program includes student and teacher portals each having various permissions and access to information stored in the databases of the computer system. The application program provides a virtual classroom environment wherein students can interact with lessons, courses, and assessments. The system also provides the comprehensive analysis of student progress as they interact with the various assessments. This provides both the students and the teacher with a convenient means of monitoring progress.

The application program may be used by the teacher to efficiently identify concepts which the students have been successful learning, as well as concepts which the students have not been successful learning. This feature is useful for the teacher in that the concepts which are not yet successfully mastered by the students are easily identified, allowing the teacher to focus on reinforcing specific concepts. In the same manner, the application program provides an efficient means for the student to identify concepts they need further work mastering.

In one aspect, the application program include a student portal provided to each of one or more students. The student portal includes a student dashboard interface to display a plurality of metrics associated with the learning progress of their students.

In one aspect, a teacher portal is provided to a teacher and includes a classroom dashboard to display a plurality of student metrics associated with the students learning progress or and the classroom learning progress.

In one aspect, a marketplace interface enables the teacher to acquire one or more of the mats. The marketplace interface can be used to view various mats which correspond to lessons, courses, assessments, and other material associated with various concepts. Once the teacher acquires the mat, they are provided access to the lessons, courses, assessments, and other material associated with various concepts.

In one aspect, a course module provides the lesson and displays, via a display module, the lesson on the student portal.

In one aspect, a communication module enables the transmission of a message between two or more users.

In one aspect, the classroom dashboard interface provides a comprehensive view of a plurality of student metrics associated with the one or more concepts. In such, the teacher can utilize the classroom dashboard interface to monitor progress of their students.

In one aspect, the mat is utilized as a problem solving device during the assessment. Alternatively, the mat is used in a real-world classroom environment and may be used during the assessment.

The embodiments also provide a method for providing movement-based learning using the mat as a teaching aid as well as an application program which provides a virtual classroom environment. Once the user registers with the system, they are able to select if they are a teacher or student. This selection directs the user to either the teacher portal or the student portal of the application program. If the user is a student, the student will select a classroom with which they are associated. The system associates one or more courses with which access is enabled using the learning module and course module. Next, the student interacts with various lessons associated with each course which are provided by the learning and course modules. The student may also interact with assessments provided by the assessment module. Data is collected and aggregated to generate results using the analysis module. The results are aggregated and displayed, via the analysis module, to display progress and completion metrics for the student as an individual, as well as the classroom (i.e., a group of students).

If the user has indicated that they are a teacher, they are provided access to the teacher portal. The teacher may input classroom data and may input information related to each student within the classroom. Next, the teacher accesses the marketplace to acquire one or more mats. Once the mats are purchased, the system grants the teacher access to one or more lessons and/or one or more assessments associated with the mat(s) they have acquired. The mat(s) are delivered to the teacher and students interact with the mats while learning various concepts. As the students complete assignments and/or assessments, data related to student answers and learning progress is aggregated and displayed, via the analysis module. This provides the teacher with a comprehensive view of student learning progress on both the individual and classroom level.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 shows a block diagram of a computing system, according to some embodiments;

FIG. 2 shows a block diagram of a computing system and an application program, according to some embodiments;

FIG. 3 shows a block diagram of a computing system and databases, according to some embodiments;

FIG. 4 illustrates a schematic of an exemplary mat used for movement-based learning, according to some embodiments;

FIG. 5 illustrates a schematic of an exemplary mat used for movement-based learning, according to some embodiments;

FIG. 6 illustrates a screenshot of the classroom dashboard interface, according to some embodiments;

FIG. 7 illustrates a screenshot of the question of the day interface, according to some embodiments;

FIG. 8 illustrates a screenshot of the “my classrooms” interface, according to some embodiments;

FIG. 9 illustrates a screenshot of the teaching plan interface, according to some embodiments;

FIG. 10 illustrates a screenshot of the “my students” interface, according to some embodiments;

FIG. 11 illustrates a screenshot of the “my students” dashboard interface, according to some embodiments;

FIG. 12 illustrates a screenshot of the classroom dashboard interface, according to some embodiments;

FIG. 13 illustrates a screenshot of the assignment results interface, according to some embodiments;

FIG. 14 illustrates a screenshot of the “my teaching plan” interface, according to some embodiments;

FIG. 15 illustrates a screenshot of the assessments interface, according to some embodiments;

FIG. 16 illustrates a screenshot of the courses interface, according to some embodiments;

FIG. 17 illustrates a screenshot of the course overview interface, wherein the course includes the utilization of the “count to 10 mat”, according to some embodiments;

FIG. 18 illustrates a screenshot of the progress reports interface, according to some embodiments;

FIG. 19 illustrates a screenshot of the resources interface, according to some embodiments;

FIG. 20 illustrates a screenshot of the course listing interface, according to some embodiments;

FIG. 21 illustrates a screenshot of the communications interface, according to some embodiments;

FIG. 22 illustrates a screenshot of the student dashboard interface within the student portal, according to some embodiments;

FIG. 23 illustrates a screenshot of the student learning interface within the student portal, according to some embodiments;

FIG. 24 illustrates a screenshot of the student assessment interface within the student portal, according to some embodiments; and

FIG. 25 illustrates a flowchart of a method for providing movement-based learning using a mat and application program, according to some embodiments.

FIG. 26 illustrates a flowchart of a method for providing movement based learning using a mat and application program, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

In general, the embodiments disclosed herein relate to systems, methods, and devices utilized for movement-based learning. The example of teaching and learning mathematics is used herein. However, one skilled in the arts will readily understand that other subject matter may be taught using the systems, methods, and devices described in this disclosure. The embodiments include a mat which includes various numbers provided on the surface of the mat. During the learning process, the student moves around the mat in a manner dependent on the particular subject matter or concept being taught.

The system includes an application program implemented on a computing device which allows for various functionalities. The application program may be used to provide virtual lessons to the student which are selected by the teacher. The lessons may compliment the information (i.e., numbers) displayed on the mat.

In some embodiments, the application program may provide various assessments which are completed by the student. Assessment results and be analyzed and scores can be stored and reported to the teacher or other users of the system.

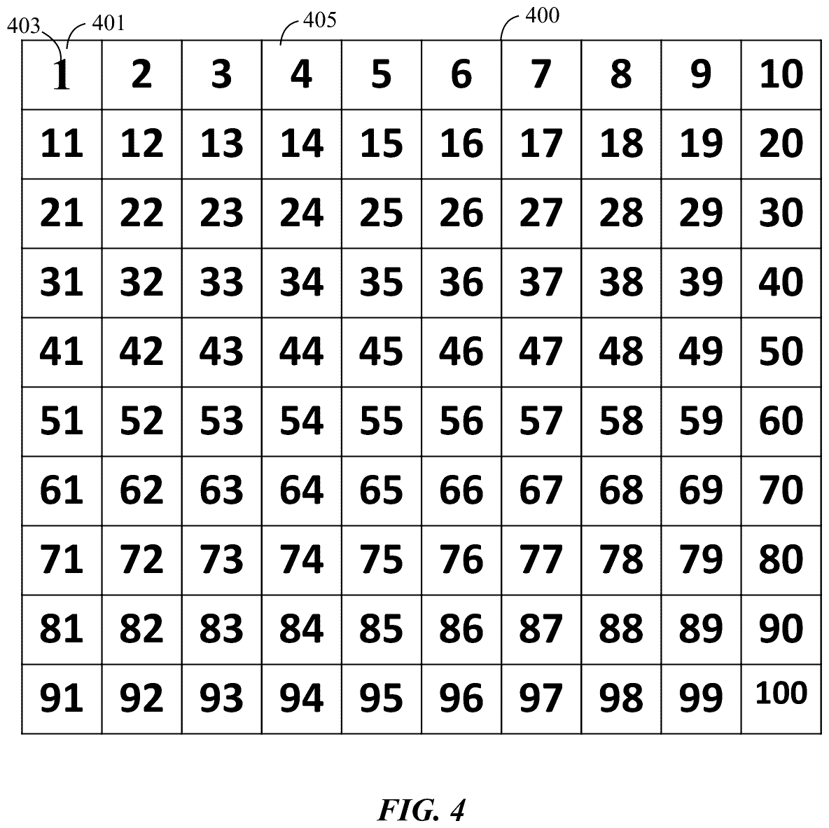

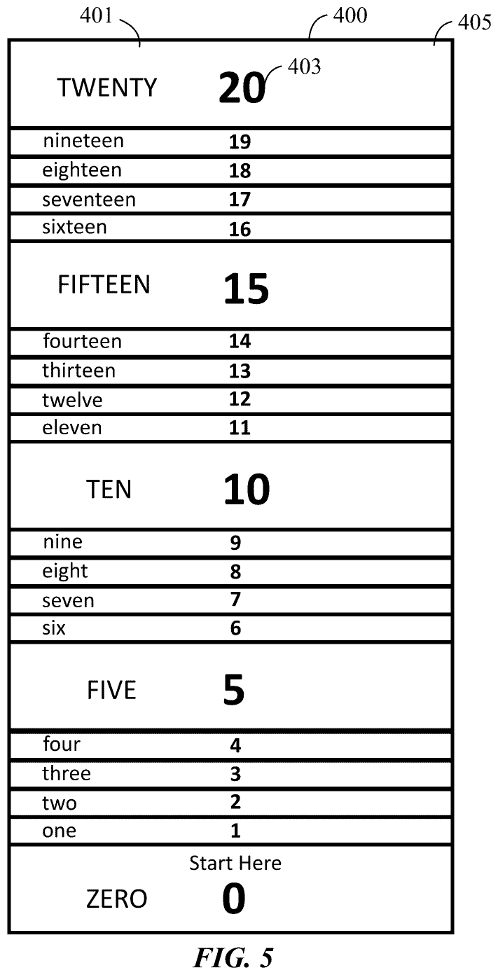

In some embodiments, the application program allows the teacher to select from a listing of courses stored in the system. The courses can each correspond to one or more mats which the teacher can select to receive (in some cases, the teacher may purchase one or more mats which grant access to the courses stored in the course database). Once the teacher selects the courses, the students may utilize the mat to learn the concept(s) taught by the course. By utilizing the mat, students engage in movement-based learning of the concept. Specific examples of concepts which can be learned using the system are described below and correspond to FIG. 4 and FIG. 5.

In some embodiments, the application program organizes the teachers' classes and students, such that the teacher can view data related to a classroom, a particular student, etc. The application program may also allow the teacher to view data related to each course, each concept, or each mat giving the teacher a comprehensive view of the students learning progress.

In some embodiments, students may utilize the application program to download content (e.g., course, assessments, etc.) which are available to them. The student portal provides a comprehensive means for learning, interacting with content, downloading content, scheduling tasks, submitting answers to assessments, and otherwise engaging with learning activities.

In some embodiments, the application program provides a communication interface for providing a means for users to communicate with one another. This can be used by teachers to communicate (e.g., send messages) to a student or group of students, by students to communicate with a teacher or teachers, by students to communicate with one another, and by teachers to communicate with one another.

As used herein, the term “user” and/or “users” may refer to students, teachers, administrators, parents or guardians of the student, and the like. The user may refer collectively to any combination of users or may refer to a particular user of the system. The third-party user may include third-party administrators, state employees, and others associated with the teaching and evaluation of the students learning. In some cases, third-party testing agencies may utilize the system.

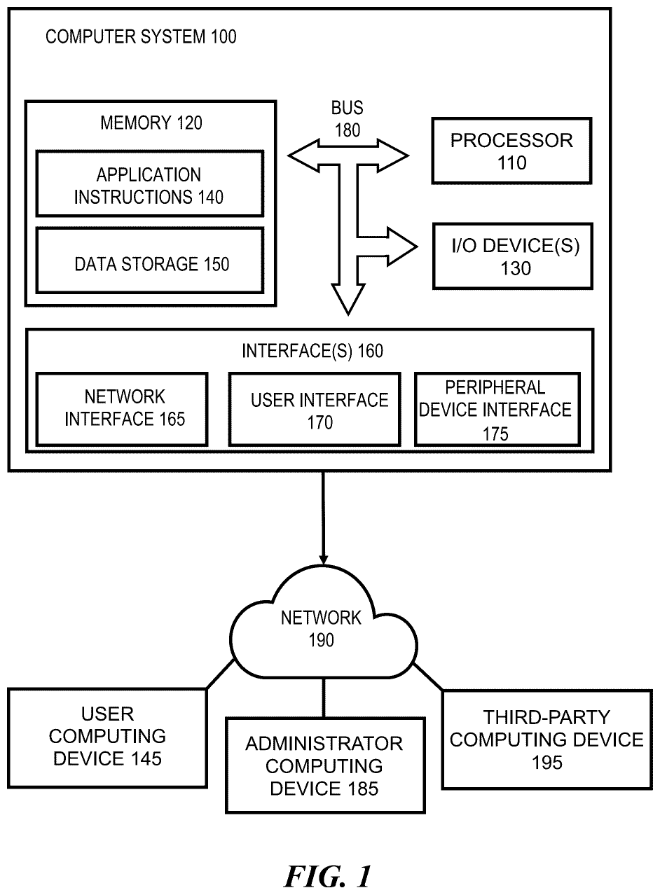

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

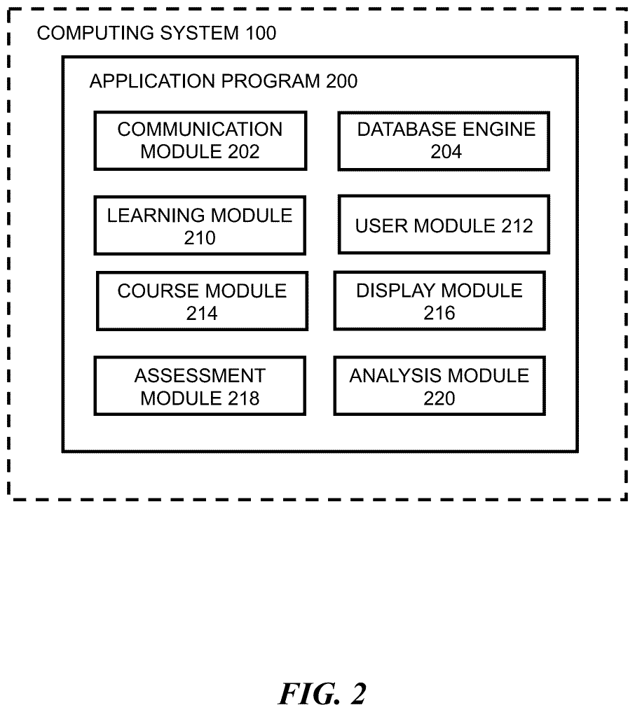

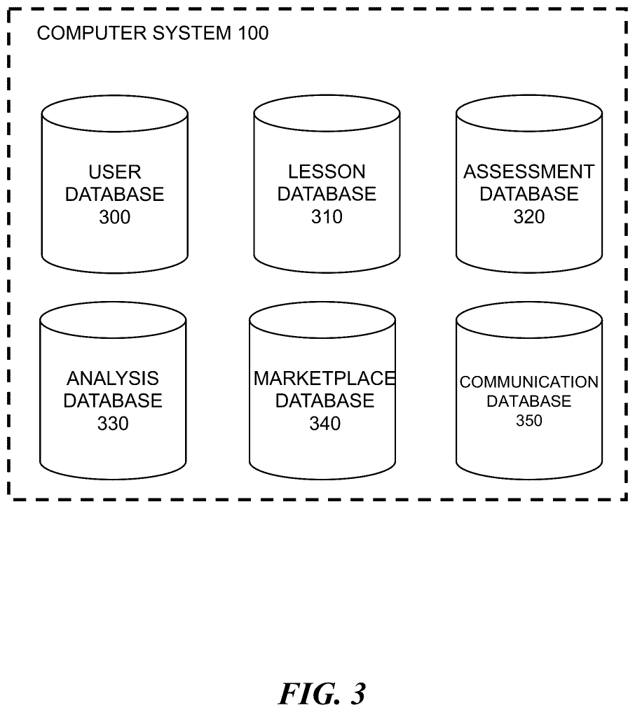

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases (see FIG. 3). In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a learning module 210, a user module 212, a course module 214, a display module 216, assessment module 218, and an analysis module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

The communication module 202 may enable, for example, the communication between users. This can include providing the ability for teachers to transmit messages to a student or group of students. In another example, the communication module 202 may enable students to transmit messages to the teacher, such as to ask questions related to a concept. In another example, the communication module 202 may enable students to communicate with one another or teachers to communicate with one another.

In some embodiments, the communication module 202 may transmit alerts to users of the system. Alerts may be related to notifications of new assignments, new assessment, due dates, new available courses, etc.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the learning module 210 is in operable communication with the application program to provide courses, generate a course schedule or plan, and otherwise provide content related to the student's movement-based learning.

In some embodiments, the user module 212 facilitates the creation of a user account for the application system. The user module 212 may allow the user to create a user profile which includes user information, preferences, and the like. The user module 212 may grant permissions to each user based on their user-type (i.e., a student, a teacher, or an administrator). The user module 212 may, for example, allow a teacher to create a teacher profile which allows the teacher to organize classes (i.e., groups of students), organize concepts which they are teaching with the aid of the system, organize mats and courses with which they have access, etc. In another example, students may create a student profile which associated the student with a teacher and/or classroom. The student profile may store content with which the student can interact. Further, the student profile may store historical data associated with the student including assignments they have completed, assessments they have completed, course results, etc.

In some embodiments, the course module 214 enables the interaction with a course by the student. The course module 214 may allow the teacher to view a listing of courses which are available. The course module 214 may allow for the interaction with virtual courses provided on the application program.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the assessment module 218 enables the interaction with assessments by the student. Assessments may be provided which relate to a course or group or courses provided by the course module 214. The assessment module 218 may also be capable of evaluating the students' performance on each assessment.

In some embodiments, the analysis module 220 is configured to analyze various aspects of the students' inputs into each course and/or assessment. The analysis module 220 may compile answers to questions and provide a comprehensive view of results or data corresponding to the progress of the student over a period of time.

FIG. 3 illustrates a block diagram of the databases in operable communication with the computer system 100. Databases include the user database 300, lesson database 310, assessment database 320, analysis database 330, marketplace database 340, and communication database 350. The user database 300 stores data related to each user (i.e., the students and teachers) who are utilizing the system. The user database 300 may store information such as the personal information of each user, as well as be operable to associate the user with one or more groups (i.e., a class), one or more courses, one or more assessments, and results thereof.

In some embodiments, the lesson database 310 stores lesson data. The lesson database 310 may store available lessons which the user may purchase and associate each lesson with a particular mat.

In some embodiments, the assessment database 320 stores assessments associated with each course. The assessment database 320 is in communication with the analysis database 330 to store data related to the results of each assessment.

In some embodiments, the marketplace database 340 stores various content which can be purchased by the teacher and/or student. For example, the marketplace database 340 stores each mat which can be purchased. The mat which is purchased is then associated with one or more courses which are then made available to the user.

In some embodiments, the communication database 350 stores communications which have been transmitted within the system. The communication database 350 may be used to recall communication between a student and a teacher to review learned topics, or to simply provide a record of communications between users.

FIG. 4 and FIG. 5 illustrate exemplary mats 400 used for movement-based learning. In specific reference to FIG. 4, the mat 400 includes a plurality of spaces 401 each having a number 403 displayed thereon. Numbers 403 may be printed in any numerical range on the top surface 405. Numbers 1-100 is shown in the illustrated example. The mat 400 illustrated in FIG. 4 can be used for various concepts including arithmetic. The mat 400 is placed on a ground surface and can be stood upon by the student throughout the learning exercise. The mat 400 shown in FIG. 5 is another examples of a mat which can be utilized for learning concepts such as arithmetic. Similar to FIG. 4, the mat 400 shown in FIG. 5 can be stood upon by the user and has numbers 403 displayed within spaces 401 on its top surface 405.

In one example, and referencing FIG. 4, the teacher instructs the student to start at the number 0 by standing off the top surface 405 of the mat 400. The teacher may then instruct the student to add 5 to the number 0. The student will then move to the space which has the number 5 displayed thereon. The teacher may then instruct the student to add 5 (or another number) to this new position (in this example the student would then move to the space 401 which has the number 10 displayed thereon). This process can be repeated, allowing for the movement-based learning of addition, subtraction, multiplication, division, or other arithmetic concepts. During the process, the student moves around the surface of the mat 400, standing on the space 401 and corresponding number 403 which indicates the answers to the teacher's prompts (e.g., if the student is standing on the number 403 reading “40”, and the teacher instructs the student to subtract 3, the student will move to the space 401 having the number 403 reading “37”).

In another example, and referencing FIG. 5, the teacher instructs the student to start at the number 5. The particular mat 400 illustrated in FIG. 5 is designed to teach the concepts of multiplying and/or dividing by 5. Numbers 403 not divisible by 5 are illustrated in smaller spaces. The teacher may instruct the student to multiply by 2, and in such the student would move correctly to the space 401 labelled with the number 403 “10”. This mat 400 may also be used for teaching the concepts of addition and subtraction.

One skilled in the arts will readily understand that the exemplary mats 400 illustrated in FIG. 4 and FIG. 5 are provided by way of example and are non-limiting. It is to be understood that many variations of mats 400 each having different variations of spacing, and numbers are contemplated.

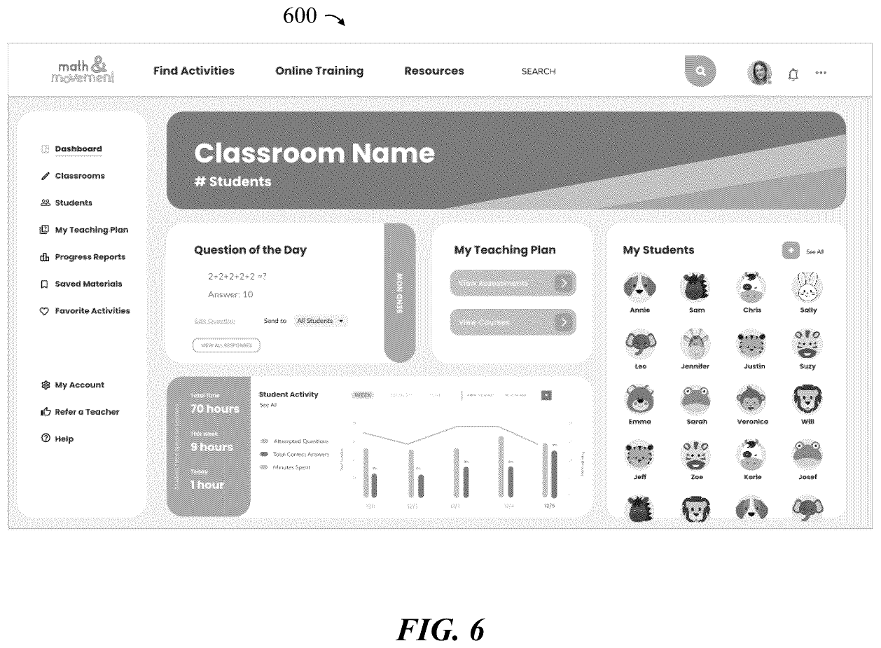

FIGS. 6-21 illustrates various screenshots of exemplary user interfaces associated with the teaching portal associated with a teacher account. FIG. 6 illustrates a screenshot of the classroom dashboard interface 600 which provides a means for viewing and interacting with information associated with a particular classroom. The classroom may be defined as a group of students. The classroom dashboard interface 600 may provide information such as the classroom name, number of students, questions of the day, teacher plan (such as a plan for the day, week, semester, course, etc.), a listing of students who are associated with the classroom, time spent interacting with the system (i.e., the time spent teaching, time spent by student learning within the real-world and or virtual classroom environment, etc.), as well student activity metrics. The student activity metrics can include time spent each day interacting with a course or courses, time spent on each course, number of students who have completed a course, assessment or other task, and the like.

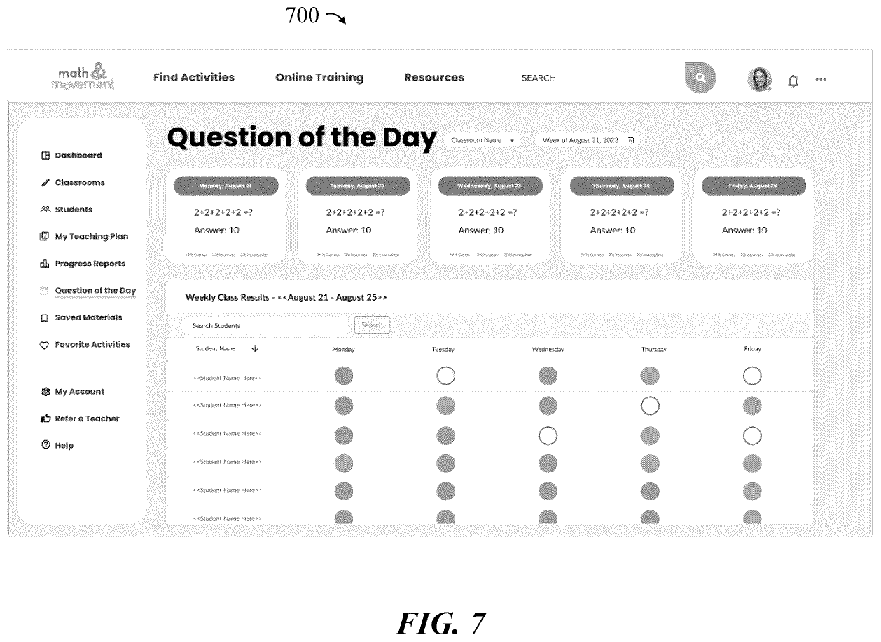

FIG. 7 illustrates a screenshot of the question of the day interface 700. The question of the day interface 700 allows the teacher to select from a listing of questions which can be transmitted to the students. The question of the day interface 700 can provide data related to each question (e.g., student responses, number of students who answered the questions, results, etc.). Previously asked questions may also be viewed by the teacher.

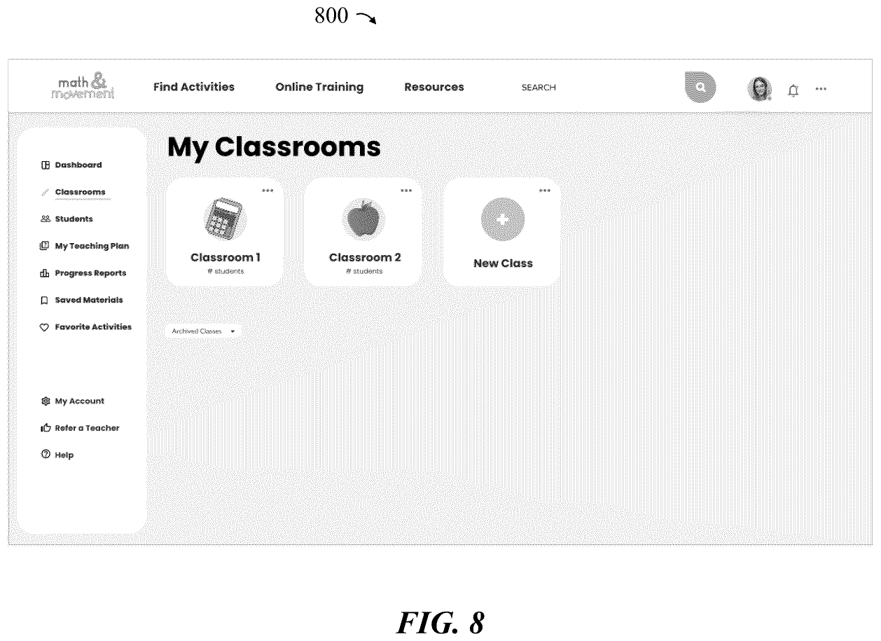

FIG. 8 illustrates a screenshot of the “my classrooms” interface 800 which allows the teacher to select from one or more classrooms they have created. Selecting a classroom enables the teacher to view various data associated with the classroom (such as by transmitting the teacher to the classroom dashboard interface illustrated in FIG. 6).

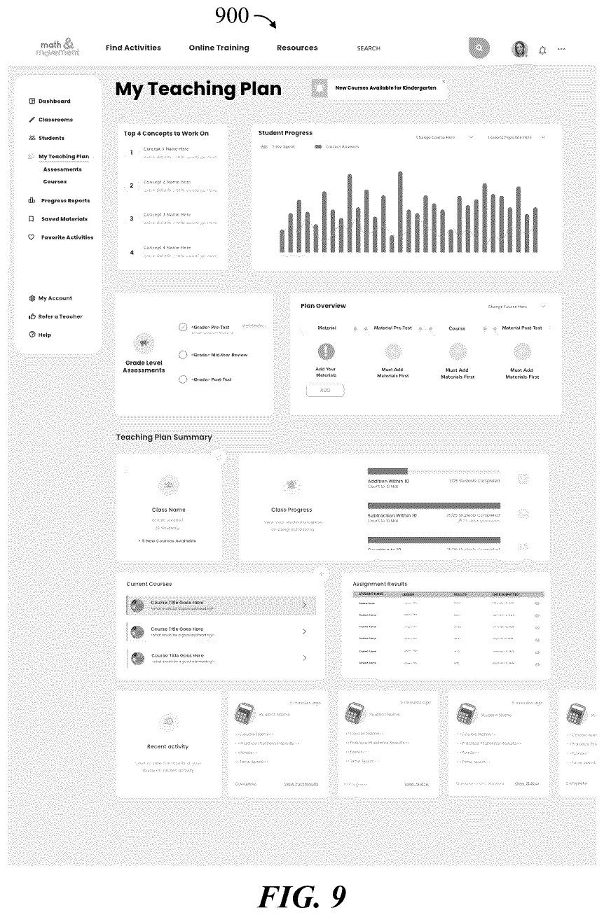

FIG. 9 illustrates a screenshot of the teaching plan interface 900. The teaching plan interface 900 displays various data and metrics which are associated with concepts the teacher is teaching to their students. The teaching plan interface 900 may display concepts, student progress, assessment data, plan overview information, a summary of the teaching plan, courses, assignments, assignment results, student activity, and the like.

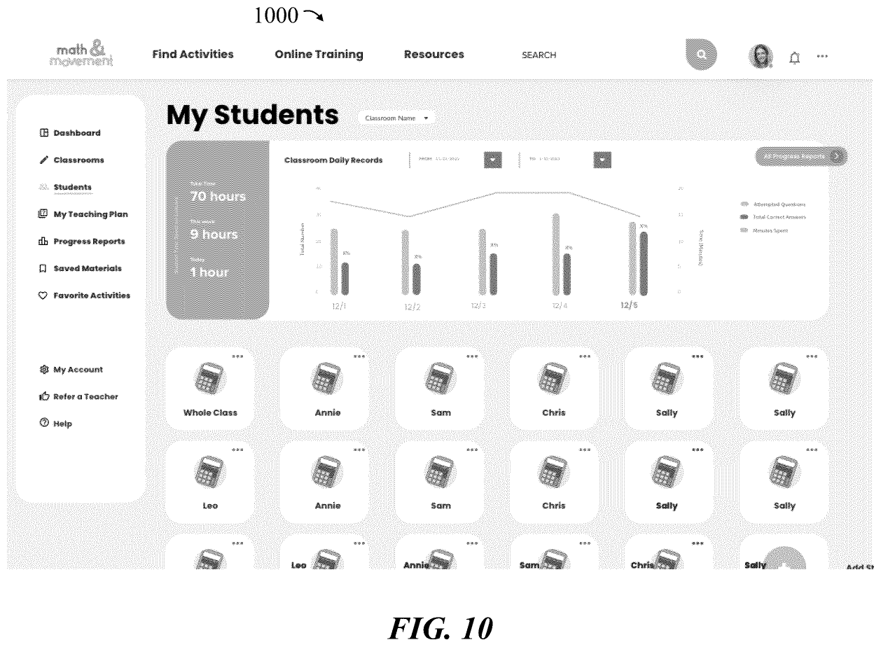

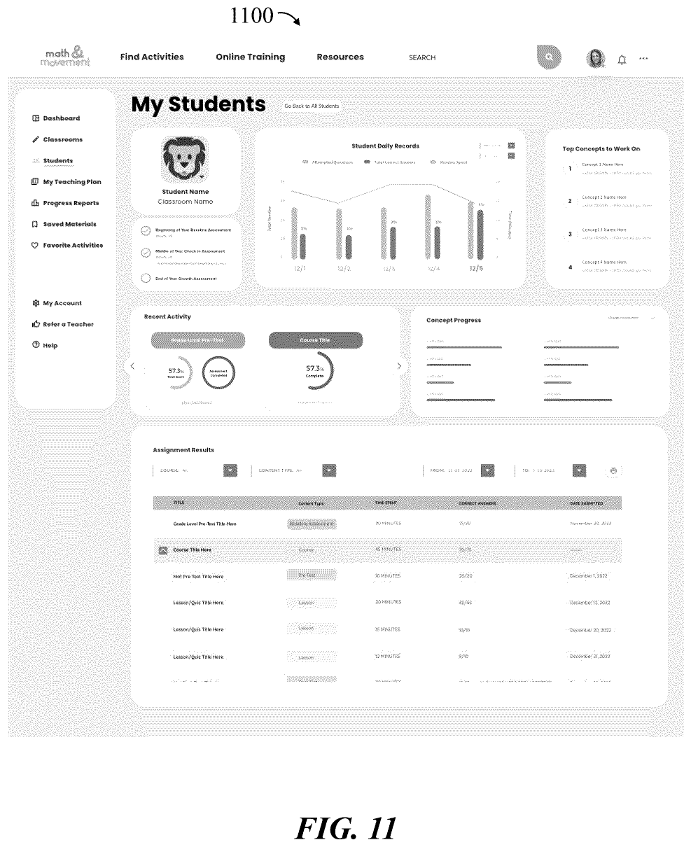

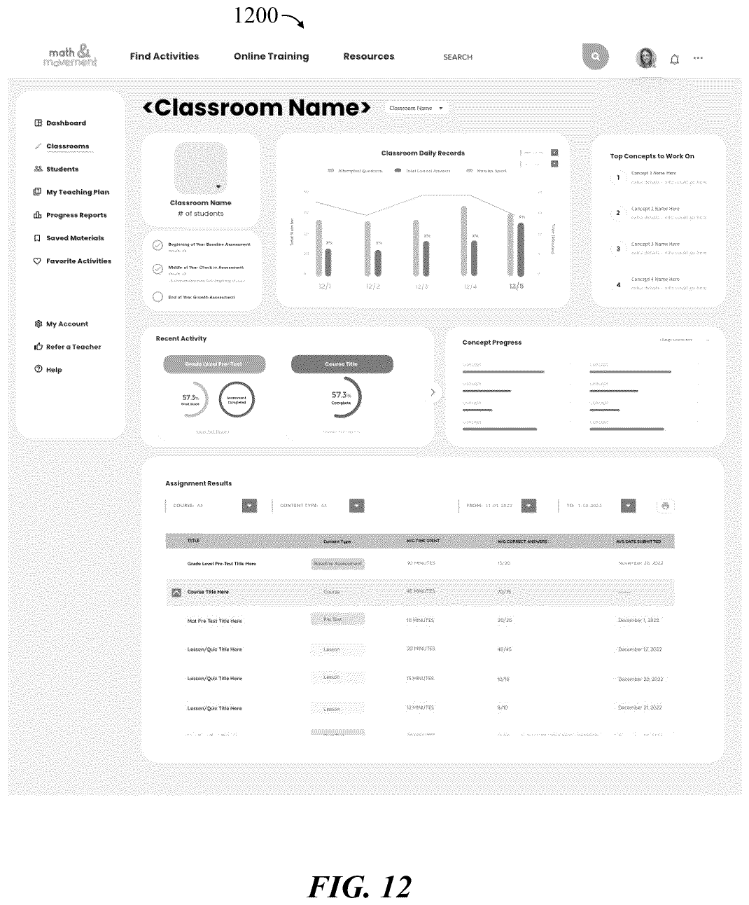

FIG. 10 illustrates a screenshot of the “my students” interface 1000 which displays a selectable tab for each student who is enrolled in a classroom or course. The “my students” interface may provide an overview of student data and metrics, as well as allow the teacher to select one or more students and view data and metrics associated with each student. Selecting an individual student transmits the teacher to the “my students” dashboard interface 1100 displayed in FIG. 11. This provides the teacher with various student metrics including their daily records, top concepts, recent activity, concept progress, assignment results, etc. A high level view of the same data may be illustrated in the classroom dashboard interface 1200 shown in FIG. 12, which aggregates data for the entire class, rather than an individual student.

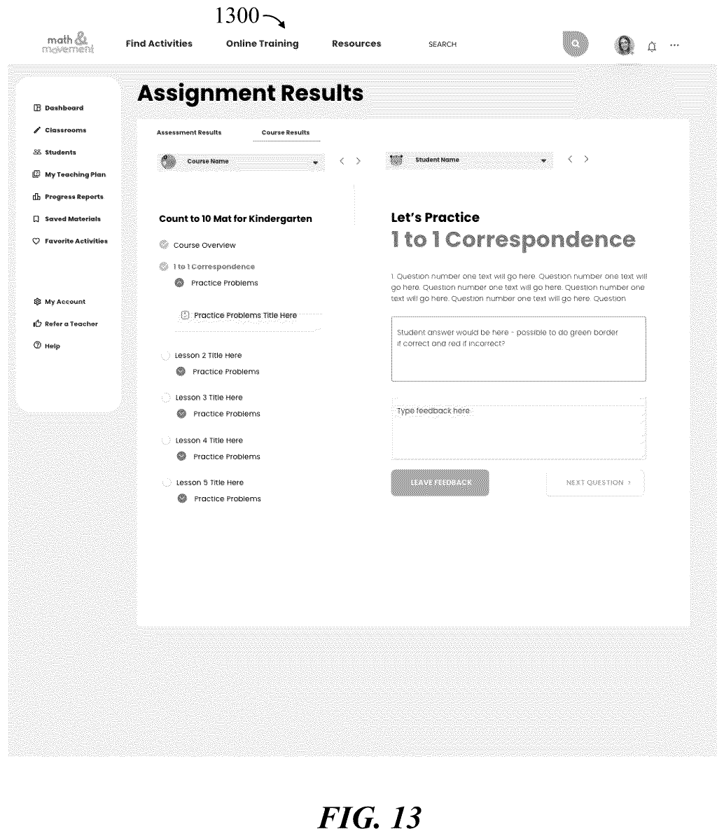

FIG. 13 illustrates a screenshot of the assignment results interface 1300. The assignment results interface 1300 provides data related to each assignment and its execution by each student. The assignment results interface may also allow for the teacher to input feedback for the assignment as a whole, or individual questions within each assignment.

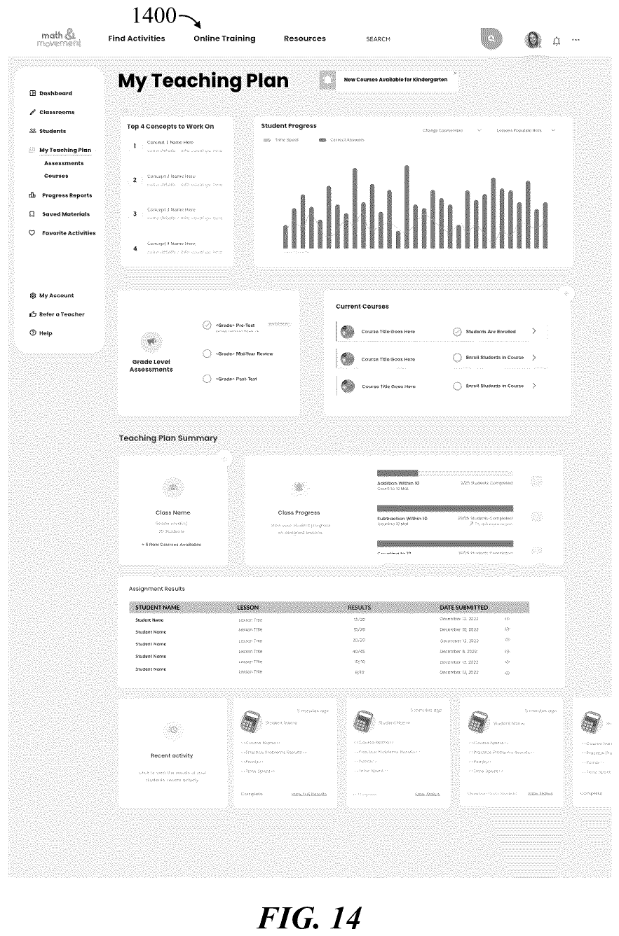

FIG. 14 illustrates a screenshot of the “my teaching plan” interface 1400. The “my teaching plan” interface 1400 provides a high-level view of student progress, courses offered, results for each course, class progress, assignment results, and assessment results.

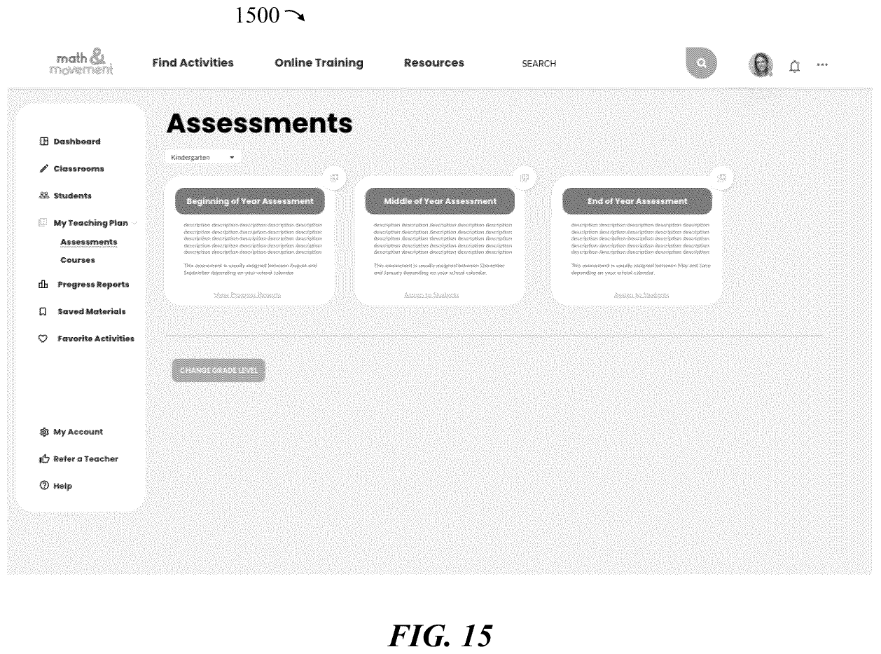

FIG. 15 illustrates a screenshot of the assessments interface 1500 wherein the teacher can view details related to one or more assessments. Assessments may be organized by grade level, course, concept, or time of year during which the assessment is to be completed.

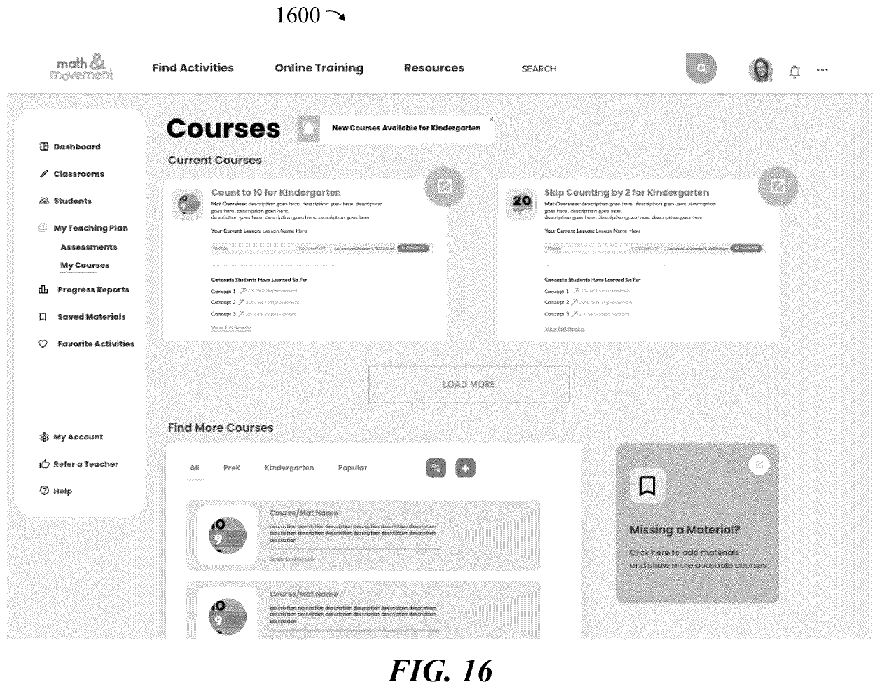

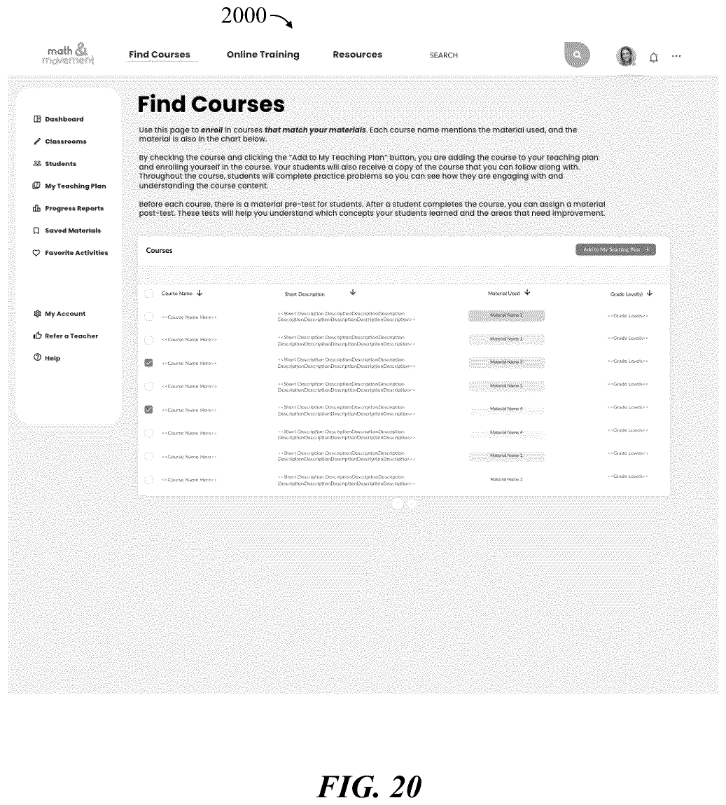

FIG. 16 illustrates a screenshot of the courses interface 1600. The courses interface 1600 includes information related to each course provided by the teacher, as well as the ability to connect to the marketplace to select and acquire (possibly by purchasing) more courses provided by the system. If the teacher selects to select one or more courses, they are transmitted to the course listing interface 2000 shown in FIG. 20. The course listing interface allows the teacher to browse courses, select courses (and mats if necessary) which they would like to provide to their students.

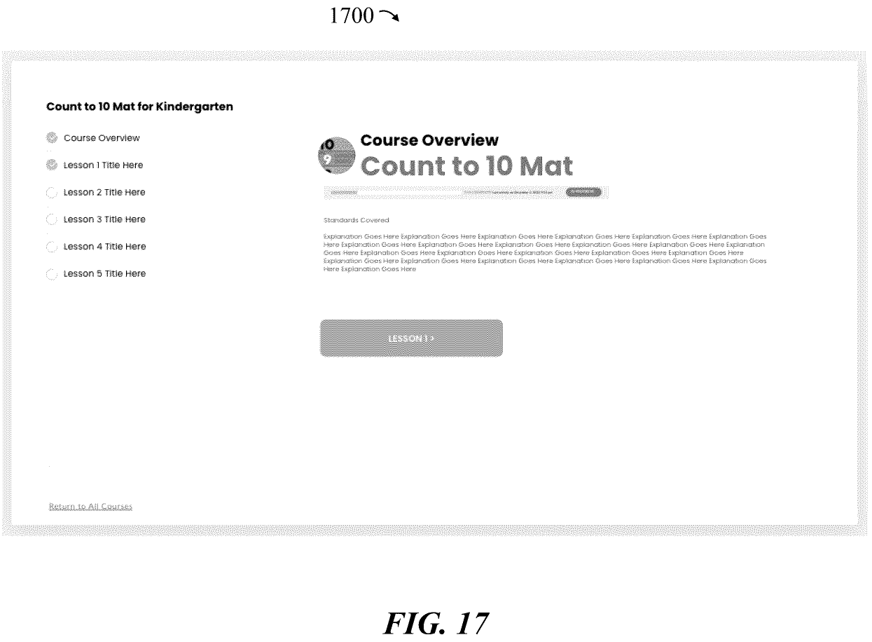

FIG. 17 illustrates a screenshot of the course overview interface 1700. In the illustrated example, a “count to 10” mat is selected. This mat is associated with a plurality of courses which facilitate teaching students to count to 10. This can include a plurality of lessons which are each associated with the selected mat. By selecting to acquire the mat (such as by purchasing the mat using the marketplace), the teacher is granted access and is able to share access to each concept, lesson, course, and/or assessment which is associated with the mat.

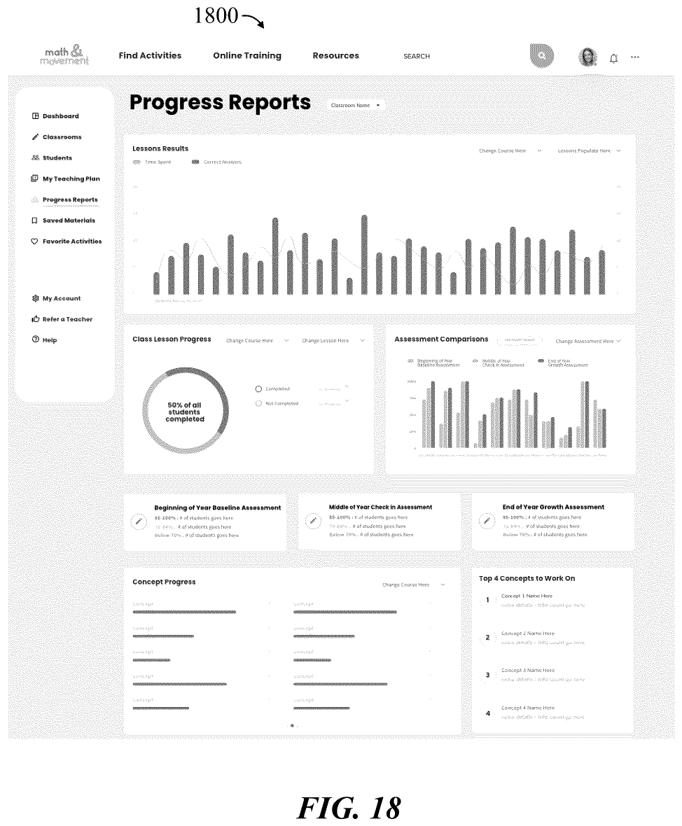

FIG. 18 illustrates a screenshot of the progress reports interface 1800. The progress reports interface 1800 provides data associated with results for each lesson or course with which the student(s) have completed. The progress reports interface 1800 provides the teacher with a comprehensive view of the students learning progress, classroom progress, and may aid in elucidating concepts which require additional instruction.

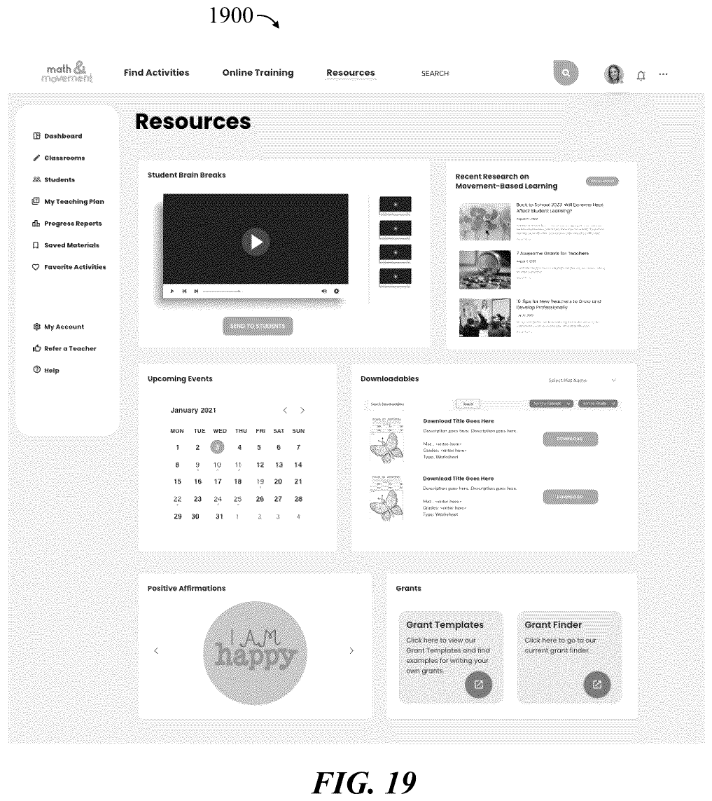

FIG. 19 illustrates a screenshot of the resources interface 1900 which provides various information which can be interacted with by the teacher. This can include media content (e.g., articles, videos, exercises, etc.) which can be utilized for teaching. The resources interface 1900 may also include a calendar features, affirmations, downloadable content, grant information, etc.

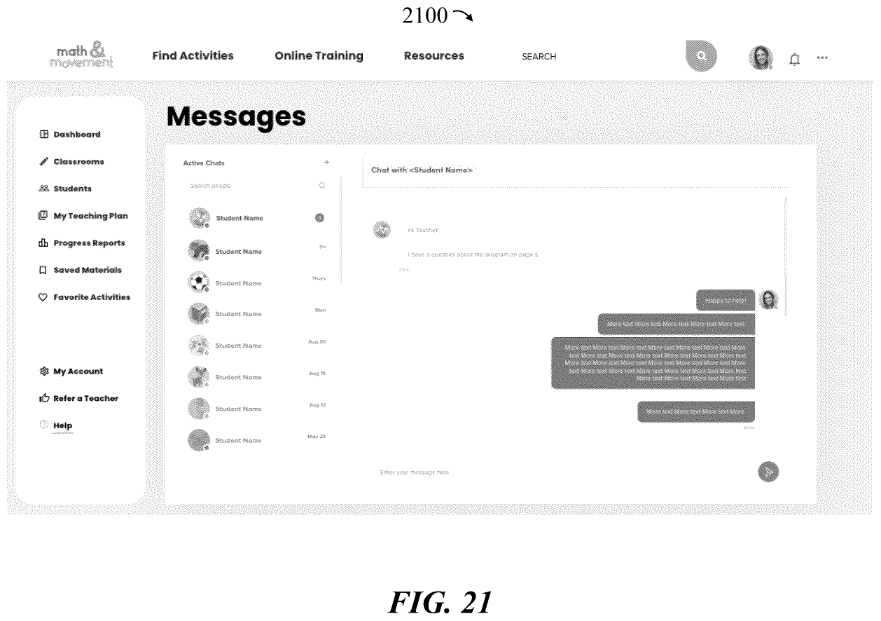

FIG. 21 illustrates a screenshot of the communications interface 2100. The communications interface 2100 allows for the transmission of communications between users of the system. This may include the ability for a teacher to message a student or group of students, as well as the ability for students to message the teacher or one another (via the student portal). In such, the communication interface 2100 provides a virtual communication environment to the users of the system.

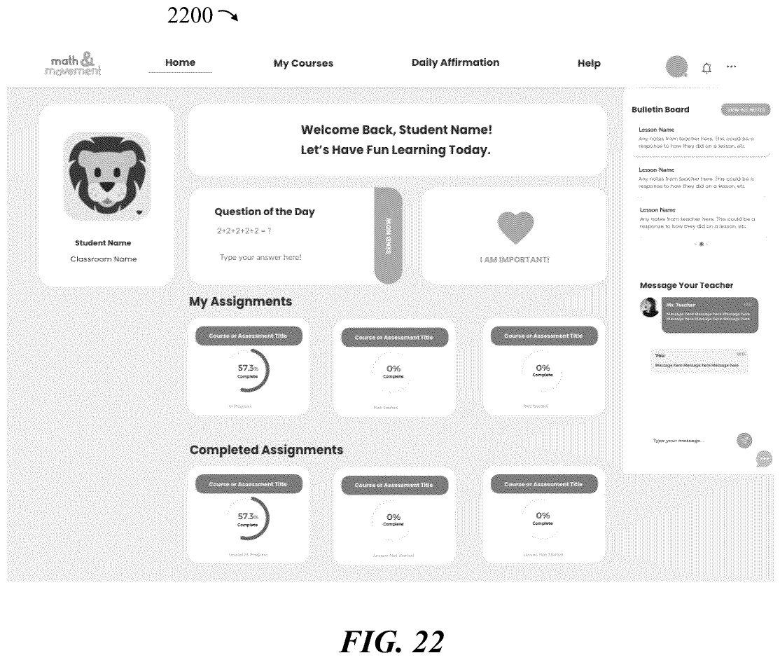

FIGS. 22-25 illustrates exemplary screenshots associated with the student portal which can be accessed by the student. FIG. 22 illustrates a screenshot of the student dashboard interface 2200 within the student portal. The student dashboard interface 2200 provides the student with various information related to the classroom(s) with which they are associated. This can include questions of the day, assignments (whether they are not yet completed or completed), assessments, messages, bulletins, grades and scores, progress, and the like. The student may navigate through various courses, a home dashboard (shown in FIG. 22), daily affirmations, etc.

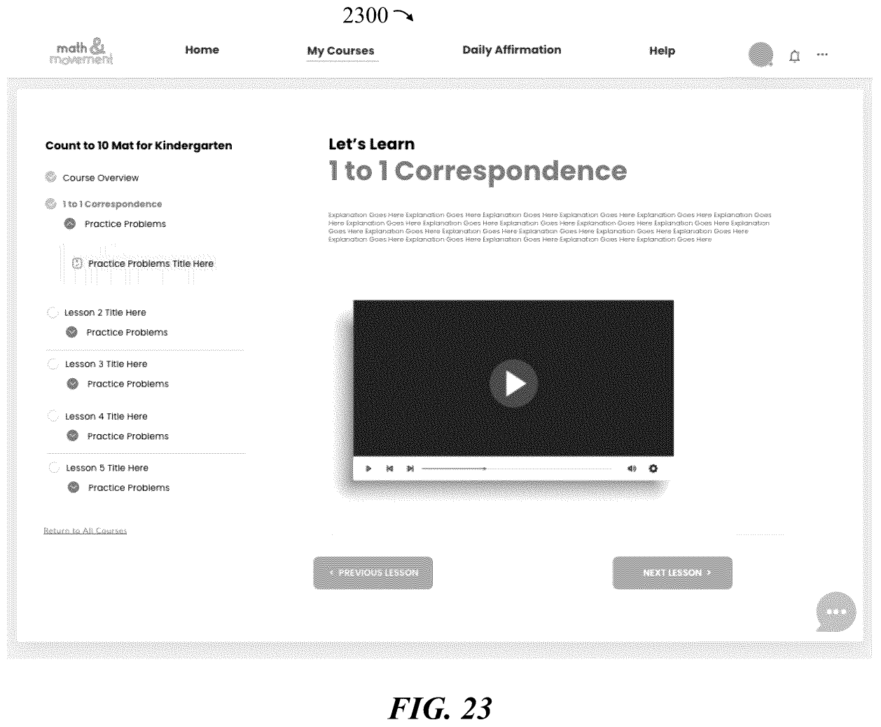

FIG. 23 illustrates a screenshot of the student learning interface 2300. The student learning interface 2300 provides access to courses (i.e., lessons) with which they may interact. Each course may include various forms of content including videos, images, articles, and other means of presenting information. The student learning interface 2300 can be used in tandem with the mat(s) associated with the particular lesson or separately, such that the lesson can be interacted with away from the real-world classroom environment. If the mat is utilized in tandem with the application program, the student may choose to utilize the mat as a problem-solving device to aid them in answering questions presented in the lesson.

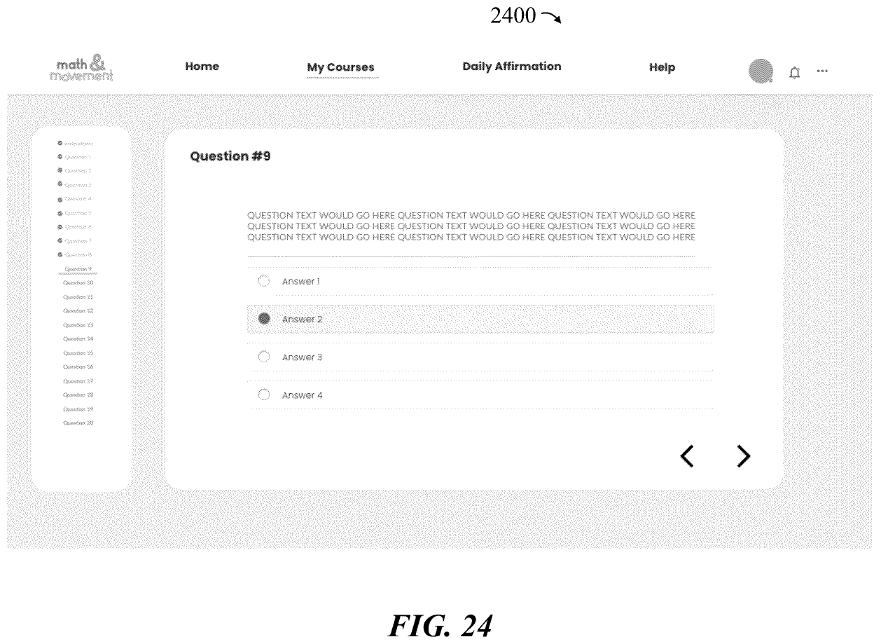

FIG. 24 illustrates a screenshot of the student assessment interface 2400. The assessment interface 2400 may be used to input answers to a plurality of questions which comprise the assessment. The mat may be used in tandem with the assessment provided by the student assessment interface 2400 or may be used separately. If the mat is utilized in tandem with the application program, the student may choose to utilize the mat as a problem-solving device to aid them in answering questions presented in the assessment.

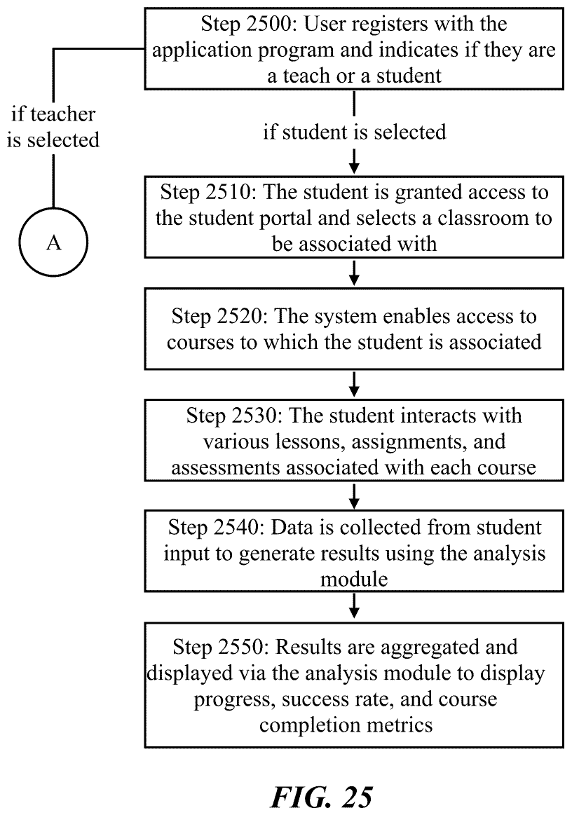

FIG. 25 illustrates a flowchart of a method for enabling movement-based learning using a mat and application program. In step 2500, the user registers with the application program and indicates if they are a teacher or student. During step 2510, if the user is a student, the student will select a classroom with which they are associated. In step 2520, the system associates one or more courses with which access is enabled using the learning module and course module. In step 2530, the student interacts with various lessons associated with each course which are provided by the learning and course modules. The student may also interact with assessments provided by the assessment module. In step 2540, data is collected and aggregated to generate results using the analysis module. In step 2550, the results are aggregated and displayed, via the analysis module, to display progress and completion metrics for the student as an individual, as well as the classroom (i.e., a group of students).

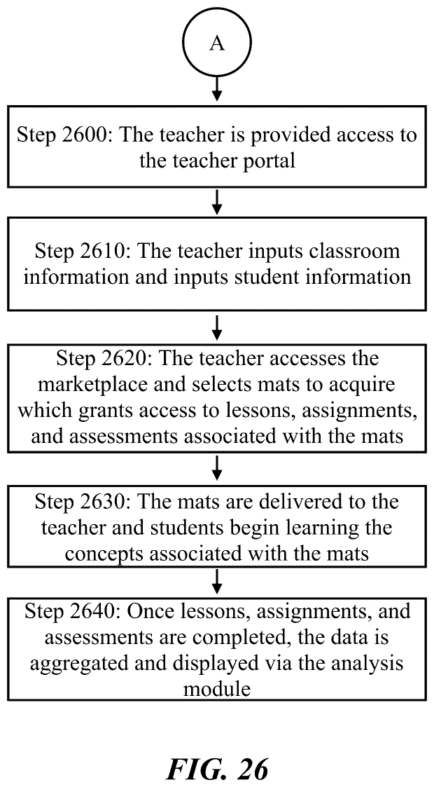

FIG. 26 illustrates a flowchart of a method for providing movement-based learning using a mat and application program. In step 2600, the user has indicated they are a teacher and are provided access to the teacher portal of the application program. In step 2610, the teacher inputs classroom data and may input information related to each student within the classroom. In step 2620, the teacher accesses the marketplace to acquire one or more mats. Once the mats are purchased, the system grants the teacher access to one or more lessons and/or one or more assessments associated with the mat(s) they have acquired in step 2620. In step 2630, the mat(s) are delivered to the teacher and students interact with the mats while learning various concepts. In step 2640, as students complete assignments and/or assessments, data related to student answers and learning progress is aggregated and displayed, via the analysis module. This provides the teacher with a comprehensive view of student learning progress on both the individual and classroom level.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A mat for movement-based learning, the mat comprising:
a projector or a plurality of lights to display or project an image of the mat onto a surface, the mat including a plurality of spaces each having at least one number, word, science concept, or literacy concept displayed thereon, the mat dimensioned to be moved over or stood upon by a student engaged in a movement-based learning activity.

2. The mat of claim 1, further comprising a student portal provided to each of one or more students, the student portal including a student dashboard interface to display a plurality of metrics associated with the students' learning progress.

3. The mat of claim 1, further comprising a teacher portal provided to a teacher, the teacher portal including a classroom dashboard to display a plurality of student metrics associated with the students learning progress or the classroom learning progress.

4. The mat of claim 3, further comprising a marketplace interface to enable the teacher to acquire one or more of the mats.

5. The mat of claim 4, wherein the acquisition of the one or more mats grants access to a course associated with the one or more mats the teacher acquires.

6. The mat of claim 2, further comprising a course module to provide the lesson and display, via a display module, the lesson on the student portal.

7. The mat of claim 1, further comprising a communication module to permit the transmission of a message between two or more users.

8. The mat of claim 1, wherein a classroom dashboard interface provides a comprehensive view of a plurality of student metrics associated with the one or more concepts.

9. The mat of claim 1, wherein the mat is utilized as a problem solving device during the assessment.

10. A system for movement-based learning using a mat and computer system, the system comprising:
a mat including a plurality of spaces each having at least one number, word, science concept, or literacy concept displayed thereon, the mat dimensioned to be stood upon by a student engaged in a movement-based learning activity;
at least one user computing device in operable connection with a user network;
an application server in operable communication with the user network, the application server configured to host an application system for providing a virtual classroom environment, the application system having a user interface module for providing access to the virtual classroom environment through the user computing device;
a marketplace interface to permit the selection of the mat and provide access, via a learning module, to at least one course associated with the selected mat; and
an assessment module to provide at least one assessment, via an assessment interface, associated with the one or more concepts, the assessment module to receive one or more student inputs and transmit the one or more student inputs to an analysis module operable to analyze the one or more student input to the assessment interface and to evaluate the student input to determine if the user input is correct, wherein the analysis module generates a report displayed on a progress reports interface provided to a teacher,
wherein the progress reports interface provides a summary of student progress and classroom progress.

11. The system of claim 10, further comprising a student portal provided to each of one or more students, the student portal including a student dashboard interface to display a plurality of metrics associated with the students' learning progress.

12. The system of claim 10, further comprising a teacher portal provided to a teacher, the teacher portal including a classroom dashboard interface to display a plurality of student metrics associated with the students' learning progress and the classroom learning progress.

13. The system of claim 12, further comprising a resources interface to provide a plurality of information associated with the concept, the one or more lessons, and the one or more courses.

14. The system of claim 13, wherein the acquisition of the one or more mats grants access to a course associated with the one or more mats the teacher acquires.

15. The system of claim 10, further comprising a course interface to display a listing of the one or more courses made accessible via the acquisition of the mat.

16. The system of claim 10, further comprising a communication module to permit the transmission of a message between the teachers and the students.

17. The system of claim 10, wherein a classroom dashboard interface provides a comprehensive view of a plurality of student metrics associated with the one or more concepts.

18. The system of claim 10, wherein the mat is utilized as a problem solving device during the assessment.

19. A method for facilitating movement-based learning using a mat and computer system, the method comprising the steps of:
associating a student with a classroom to enable access, via a learning module, to at least one lesson;
interacting, via the student, with a mat including a plurality of spaces each having at least one number displayed thereon, the mat dimensioned to be stood upon by a student engaged in a movement-based learning activity;
interacting, via the student, with at least one assessment provided by an assessment module;
analyzing a plurality of data collected from student inputs associated with the assessment to generate a progress report, wherein the progress report is displayed on a teacher portal to provide an efficient means of interpreting student learning progress by a teacher.

20. The method of claim 19, wherein the teacher is granted access to the teacher portal, wherein the teacher portal includes a classroom dashboard interface to display a plurality of student metrics associated with the students' learning progress and the classroom learning progress, and wherein the teacher portal grants access to a marketplace interface to permit the teacher to select one or more mats associated with one or more concepts.
